(19) United States
(12) Patent Application Publication
(10) Pub. No.: US 2013/0296217 A1
(43) Pub. Date: Nov. 7, 2013

(54) OSCILLATOR CIRCUIT AND SYSTEM

(71) Applicants: Ehsan Afshari, Ithaca, NY (US); Guansheng Li, Ithaca, NY (US)

(72) Inventors: Ehsan Afshari, Ithaca, NY (US); Guansheng Li, Ithaca, NY (US)

(73) Assignee: CORNELL UNIVERSITY, ITHACA, NY (US)

(21) Appl. No.: 13/880,482

(22) PCT Filed: Oct. 21, 2011
(86) PCT No.: PCT/US11/57276

§ 371 Date: Jul. 19, 2013

Related U.S. Application Data
(60) Provisional application No. 61/405,269, filed on Oct. 21, 2010.

(51) Int. Cl. C11D 3/42

(52) U.S. Cl. CPC C11D 3/42
USPC 510/300; 510/299

(57) ABSTRACT

The present invention is directed to a distributed dual-band oscillator suitable for low-phase-noise applications. The invention is configured to switch between the odd and even resonant modes of a fourth-order resonator. The switches used for mode selection do not conduct current and therefore do not affect the quality factor (Q) of the resonator. The benefit of this feature is relatively low phase noise.

### CROSS-REFERENCE TO RELATED APPLICATIONS

This application is based on U.S. Provisional Patent Application Ser. No. 61/405,269 filed on Oct. 21, 2010, the content of which is relied upon and incorporated herein by reference in its entirety, and the benefit of priority under 35 U.S.C. §119(e) is hereby claimed.

### BACKGROUND OF THE INVENTION

1. Field of the Invention

The present invention relates generally to communications systems, and particularly to wireless communications systems.

2. Technical Background

Wireless telephones are ubiquitous. The International Telecommunications Union (ITU) estimated that the number of mobile phone subscriptions worldwide has reached 4.6 billion. The agency further estimated that the number would increase to five billion by the end of 2010. It is estimated that one billion of these subscriptions were for mobile broadband service. According to the agency, mobile phone providers offer advanced services and handsets in more developed countries, while people in developing countries increasingly use mobile phones for health and banking services. As an example, simple, low-end mobile phones are being used by doctors to send medical reminder messages to patients, or for text messages that instruct patients how to take complex medications. These are some of the reasons why there has been no drop in the demand for mobile communications services even during the most recent economic crisis.

For the sake of discussion, a block diagram of a conventional wireless telephone 1000 is provided in FIG. 1. Some mobile telephones may be more sophisticated than the one depicted in FIG. 1 and there may be others less sophisticated. A typical conventional telephone 1000 includes digital processor circuitry 1002 that includes an internal bus for communicating information between the various functional blocks shown in FIG. 1. The telephone 1000 may include read only memory (ROM) 1004 that is used to store static information and instructions for the processor 1002. ROM 1004 may store the permanent instructions used for “booting up” the telephone when power is applied. Processor 1002 is also connected to dynamic memory, such as random access memory (RAM 1006), that is used for storing information and instructions that are executed by the processor 1002. RAM 1006 may be used for storing temporary variables or other intermediate information. Briefly stated, the processor and the memory components superficially described above, run the software applications provided with the phone. For example, low-end mobile phones offer basic telephony functions, as well as other basic functions. Depending on the processor 1002 and the application software, a wireless device may also offer music, video, streaming video, alarms, memo recording, PDA functions, internet, email, etc.

Referring back to FIG. 1, the wireless phone includes a keyboard 1008 that allows the user to enter telephone numbers or other data, depending on the application. A color LCD screen 1010 may be provided to display information, pictures, etc. The processor 1002 also provides interface circuits connected to a microphone and one or more speakers (i.e., see functional block 1012). Many mobile phones offer a digital camera (1014) for transmission of digital photographs over the wireless network.

Essentially, the wireless telephone includes one or more radios that are configured to transmit and receive RF signals. For the wireless telephone to be of any use at all, the information obtained from the blocks on the right side of processor 1002 must be transmitted over the wireless network using the RF transceivers (1020-1026) and antennas 1018 disposed on the left side of the processor (as depicted in FIG. 1). Likewise, RF signals captured by the antenna 1018 must be routed to the appropriate transceiver and then provided to the correct output device on the right side of the processor. For example, voice data obtained from an RF signal must be converted into an analog signal and further converted into sound by a speaker (1012).

Wireless telephones may include more than one RF transceiver. The GSM transceiver 1020, for example, refers to a standard developed for second generation (2G) wireless networks. Wi-Fi transceiver 1022 allows the user to wirelessly connect to the internet. A Blue-tooth transceiver 1026 allows a blue tooth equipped device to communicate with another blue-tooth device over short distances. These various communication standards are mentioned here because it may be helpful to the reader's understanding that each of these standards specify the RF frequencies over which data is transmitted and received.

RF transceivers employ reference signals that are used to modulate information bearing signals for transmission, and demodulate information bearing signals for use by the receiver. Modulation usually means that the information bearing signal is translated to a higher frequency and demodulation usually means that the information bearing signal is translated to a lower frequency. This process is described below in more detail (See FIG. 2). The reference signal employed by each RF transceiver depicted in FIG. 1 is generated by a device known as a local oscillator. Because the various RF transceivers (e.g., depicted in FIG. 1) may cover multiple frequency bands in the RF spectrum, a local oscillator that covers multiple frequency bands is quite desirable. A local oscillator device configured to cover a wide frequency band, and/or multiple frequency bands, could reduce the number of oscillators used in a single wireless device. A multi-band local oscillator would therefore be more efficient from a cost, size, and power consumption standpoint.

FIG. 2 is a high-level schematic view of a communication channel and is used to illustrate the effects of phase noise in a local oscillator. The left side of FIG. 2 shows the transmit side of a first user's transceiver, whereas the right side shows the receive side of a second user's transceiver. The first user and the second user are communicating with each other over an RF channel. Persons skilled in the art will understand that an RF channel is defined by frequency, band width, modulation type and other such characteristics. On the transmit side, sound, text or video data are digitized and converted into an intermediate frequency (IF) signal. The local oscillator (LO) provides an RF carrier signal. When these two signals are multiplied by the mixer 10201, an RF signal is generated and directed to antenna 1018 for transmission over the air. As shown, phase noise is transmitted along with the information bearing signal. Both of these signals are captured by antenna 1018 on the receive side of the transceiver. The received RF signals are demodulated by the mixer 10201 and converted into an intermediate frequency. Thus, in addition to the information bearing signal, the received IF signal includes noise. One measure of system performance is the signal-to-noise ratio (SNR). Needless to say, excessive noise degrades the performance of the wireless device and drives the SNR downwardly.

FIG. 3 is a schematic of a conventional single-band oscillator 100. The conventional oscillator includes a resonator portion 102 coupled to an active network 104. Stated briefly, the resonator includes a capacitor C disposed in parallel with an inductor L. The values of the inductor L and capacitor C are selected such that the circuit resonates at one resonant frequency. The active network 104 is shown to include transistors 106, 108 and feedback network 110. The active network may be thought of as an energy compensation network that is configured to start and sustain oscillation in the resonator circuit 102. In this conventional design, the output V+/− provides a differential signal at the resonant frequency. The conventional single tank oscillator of FIG. 3 features an undesirable trade-off—power for phase noise—this trade-off is often implemented by halving the tank impedance and doubling the power consumption, which lowers the phase noise by half. One drawback to this technique is that it may require impractically small inductances in order to meet the stringent phase noise specifications of low voltage power supply applications.

As shown in FIG. 1, wireless design is transitioning from single-mode to multi-mode systems that support multiple communication standards that operate in various frequency bands (e.g., GSM, WCDMA, etc.). As noted above, a major challenge in implementing these systems relates to the design of a local oscillator (LO) device that is capable of covering a wide RF spectrum (or multiple spectral bands) while simultaneously meeting stringent phase noise requirements. This goal is usually beyond the capability of a single-tank LC voltage-controlled oscillator (VCO) that uses variable capacitors (varactors) for continuous frequency tuning. As a result, there has been an increasing interest in LC oscillators that switch between multiple frequency bands.

In one multi-band oscillator scheme under consideration, multiple conventional LC oscillators are used, with each oscillator being tuned to a different frequency. One LC oscillator is enabled at a time to obtain a reference signal having the desired frequency. When another reference frequency is required, the oscillator is turned OFF and another LC oscillator is enabled to provide it. One drawback to this approach is that there is always at least one inductor, and possibly more, that is in idle.

Another technique under consideration is to use a switched tunable resonator. In this technique, the inductance and capacitance of the LC resonator are controlled by MOS switches to obtain the desired resonant frequency. One drawback with this approach is that these switches usually insert resistance in critical current paths such that the resonator's quality factor is degraded and the phase noise deteriorates significantly.

Existing wide-band/multi-band VCO techniques are also being considered. However, the phase noise performance of these state-of-the-art multi-band oscillators is generally inferior to single-band LC oscillators.

What is needed, therefore, is an oscillator design that covers a wide RF frequency spectrum by employing band switching, without impairing phase noise performance.

### SUMMARY OF THE INVENTION

The present invention addresses the needs described above by providing a distributed dual-band oscillator suitable for low-phase-noise applications. Stated briefly, the present invention switches between the odd and even resonant modes of a fourth-order LC resonator. In contrast to other switched-resonator designs, the switches used for mode selection do not conduct current and therefore do not affect the quality factor of the resonator. This feature of the invention leads to low phase noise. For example, analysis of the present invention shows that it achieves the same phase-noise figure-of-merit (FoM) as a single-bank LC oscillator that uses the same inductor and active core. The analysis was verified in a prototype that was implemented using 0.13 μm CMOS process. The implementation draws a current of 4 mA from a 0.5V power supply and achieves a FoM of 194.dB at the 4.9 GHz band and 193.0 dB at the 6.6 GHz band, which is the same as the conventional stand-alone LC oscillator depicted in FIG. 3.

One aspect of the present invention is directed to a resonator circuit that includes a first tank circuit configured to resonate at a first resonant frequency. The first tank circuit includes a first differential output. A second tank circuit is configured to resonate at the first resonant frequency; the second tank circuit includes a second differential output. The resonator circuit also includes a reactive network coupled to the first tank circuit and the second tank circuit such that the resonator circuit is configured to resonate at the first resonant frequency and at least one second resonant frequency. The first resonant frequency and the at least one second resonant frequency are not harmonically related.

In another aspect, the present invention is directed to a communications system that includes a frequency selective resonator circuit having a first tank circuit that is tunable to a first resonant frequency within a first predetermined band of frequencies. The first tank circuit includes a first differential output. The frequency selective resonator circuit further includes a second tank circuit that is also tunable to the first resonant frequency within the at least one first predetermined band of frequencies. The second tank circuit includes a second differential output. The frequency selective resonator circuit further includes a reactive network coupled between the first tank circuit and the second tank circuit such that the frequency selective resonator circuit is configured to resonate at the first resonant frequency and at a second frequency within a second predetermined band of frequencies. The system further includes an energy compensation network coupled to the frequency selective resonator circuit. The energy compensation network is configured to start and sustain oscillation in the frequency selective resonator circuit such that the first differential output provides a first differential signal and the second differential output provides a second differential signal.

In yet another aspect, the present invention is directed to a communications system that includes a frequency selective resonator circuit having a first tank circuit characterized by a predetermined phase noise parameter and a second tank circuit characterized by the predetermined phase noise parameter. The first tank circuit is tunable to a first resonant frequency within a first predetermined band of frequencies and includes a first differential output. The second tank circuit is also tunable to the first resonant frequency within the at least one first predetermined band of frequencies and includes a second differential output. The frequency selective resonator circuit further includes a reactive network coupled between the first tank circuit and the second tank circuit such that the frequency selective resonator circuit is configured to resonate at the first resonant frequency and at a second frequency within a second predetermined band of frequencies. An energy compensation network is coupled to the frequency selective resonator circuit and is configured to start and sustain oscillation in the frequency selective resonator circuit such that the first differential output provides a first differential signal and the second differential output provides a second differential signal. A mode selection network is coupled to the reactive network and the frequency selective resonator circuit. The mode selection network is switchable between a first switch mode and a second switch mode. The first differential signal and the second differential signal are substantially in-phase and characterized by the first frequency in the first switch mode; the first differential signal and the second differential signal are substantially 180° out of phase and characterized by the second frequency in the second switch mode.

According to another aspect of the present invention, a method of controlling the flow of electricity, the method comprising the following steps (not necessarily in the following order except as may be explicitly specified): (a) providing an oscillator circuit comprising a band switching portion, a resonator portion and a set of output terminals, with: (i) the band switching network, the resonator portion and the set of output terminals being operatively electrically coupled to each other, (ii) the band switching portion comprising a set of switch(es) and (iii) the band switching portion being configurable between at least a first configuration and a second configuration; (b) selectively supplying electrical energy to the resonator portion in order to cause resonation in the resonator portion; and (c) configuring the set of switch(es) of the band switching potion so that: (i) when the band switching portion is in the first configuration then the resonating portion operates in odd mode and an electrical signal present at the set of output terminals will be in a first band, and (ii) when the band switching portion is in the second configuration then the resonating portion will operate in even mode and an electrical signal will present at the set of output terminals will be in a second band which is different from the first band. The resonating portion and the band switching portions are structured and/or connected so that substantially no current passes through any switch(es) of the set of switch(es) of the band switching portion when the resonating portion is operating: (i) in even mode, and (ii) in odd mode.

According to another aspect of the present invention, a wireless communication device includes: a first RF antenna; a modulator/demodulator module; a local oscillator; an IF signal supply module; and an IF signal receiving module. The local oscillator is structured and connected to selectively output a carrier signal to the modulator/demodulator module. The IF signal supply module is structured and is connected to the modulator module to supply an outgoing IF signal at a predetermined intermediate frequency to the modulator module. The modulator/demodulator module is structured and/or programmed to modulate the outgoing IF signal into an outgoing RF signal at a predetermined RF frequency based on the carrier signal from the local oscillator. The first RF antenna is structured and/or connected to: (i) receive the outgoing RF signal from the modulator/demodulator module, and (ii) transmit the outgoing RF signal wirelessly. The first RF antenna is further structured and/or programmed to receive an incoming RF signal wirelessly. The modulator/demodulator module is structured and/or programmed to demodulate the incoming RF signal into an incoming IF signal at the predetermined IF frequency. The IF signal receiving module is connected to the modulator/demodulator module to receive the incoming IF signal. The local oscillator comprises a resonating portion, a band switching and a set of output terminals. The band switching network, the resonator portion and the set of output terminals are operatively electrically coupled to each other. The band switching portion comprising a set of switch(es). The band switching portion is configurable between at least a first configuration and a second configuration. The band switching potion is structured so that: (i) when the band switching portion is in the first configuration then the resonating portion operates in odd mode and an electrical signal present at the set of output terminals will be in a first band, and (ii) when the band switching portion is in the second configuration then the resonating portion will operate in even mode and an electrical signal will present at the set of output terminals will be in a second band which is different from the first band. The resonating portion and the band switching portions are structured and/or connected so that substantially no current passes through any switch(es) of the set of switch(es) of the band switching portion when the resonating portion is operating: (i) in odd mode, and (ii) in even mode.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a block diagram of a conventional wireless telephone;

FIG. 2 is a high-level schematic view illustrating phase noise in a local oscillator;

FIG. 3 is a schematic of a conventional single-band oscillator;

FIG. 4 is a schematic of a dual-band oscillator in accordance with the present invention;

FIG. 5A is a physical model of the dual-band oscillator depicted in FIG. 4;

FIG. 5B is a two-port model of the dual-band oscillator depicted in FIG. 4;

FIG. 5C is a mathematical model of the dual-band oscillator depicted in FIG. 4;

FIG. 6 is an illustration of the even mode of the LC resonator depicted in FIG. 4;

FIG. 7 is an illustration of the odd mode of the LC resonator depicted in FIG. 4;

FIG. 8 is a plot showing the input impedance of the dual-band LC resonator, with Cₛ being tuned;

FIG. 9 is a plot showing the input impedance of the dual-band LC resonator, with Cₚ being tuned;

FIG. 10 is a plot showing the input impedance of dual-band resonator when Gₑ changes;

FIG. 11 is a plot showing the input impedance of dual-band resonator when Gₒ changes;

FIG. 12 includes a first plot showing simulated ISFs and a second plot showing the voltage waveforms of the single-band and the dual-band oscillator in the odd mode;

FIG. 13 is a schematic illustration of switch noise in even mode oscillation;

FIG. 14 is a plot comparing the phase noise of the single-band oscillator to the phase noise of the dual-band oscillator in the odd mode;

FIG. 15 is an schematic of a modified switching network in accordance with an alternate embodiment of the present invention;

FIG. 16 is a plot showing the input impedance of an implemented dual band resonator of the present invention;

FIG. 17 is a die photo of an implemented dual-band oscillator of the present invention;

FIG. 18 is a plot showing the measured phase noise of a single-band oscillator;

FIG. 19 is a plot showing the measured phase noise of the odd mode of a dual-band oscillator; and

FIG. 20 is a plot showing the measured phase noise of the even mode of a dual-band oscillator.

### DETAILED DESCRIPTION

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the dual-band oscillator of the present invention is shown in FIG. 4, and is designated generally throughout by reference numeral 10.

As embodied herein and depicted in FIG. 4, a schematic of a dual-band oscillator 10 in accordance with the present invention is disclosed. Dual-band oscillator 10 includes a resonator (12, 14), an active energy compensation network 16 and a mode selection feedback network 18.

The resonator circuit 101 includes a tank circuit 12 that is configured to resonate at a predetermined resonant frequency referred to herein as the even mode resonant frequency. Tank circuit 12 provides a first differential output (V+/−) across capacitor Cp. Resonator circuit 101 also includes a second tank circuit 12′ that is also configured to resonate at the even mode resonant frequency. The tank circuit 12′ provides a second differential output across Cp′. Thus, each LC tank circuit (12, 12′), includes a capacitor Cp and a center tapped inductor L that define the even-mode resonant frequency. The values of the capacitor Cp and the inductor L in resonator 12 are substantially equal to the values of the capacitor Cp and the inductor L in resonator 12′.

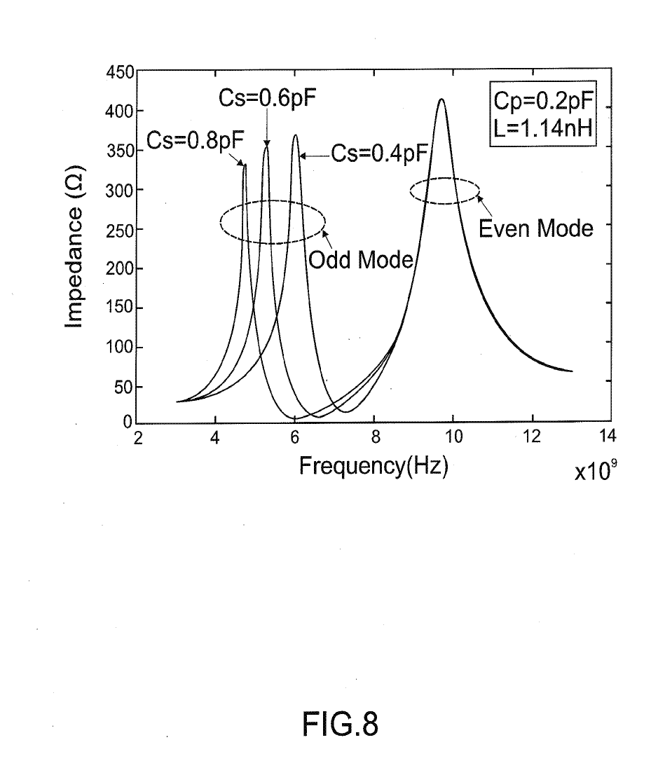

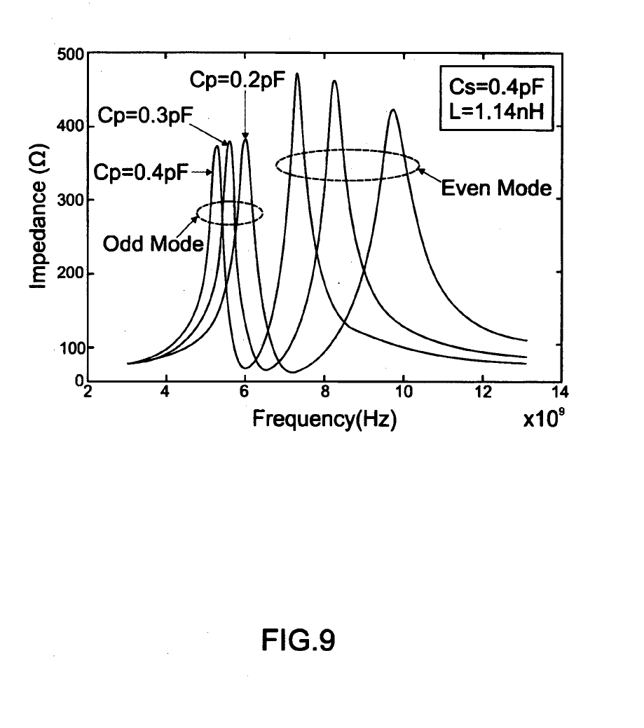

The resonator circuit 101 also includes a reactive network that includes capacitors Cs coupled between tank circuit 12 and tank circuit 12′ such that the resonator circuit 101 resonates at the even mode resonant frequency and at an odd mode resonant frequency. Note that the odd mode resonant frequency is determined by the values of capacitors Cp, capacitors Cs and inductors L. The even mode frequency is not harmonically related to the odd mode frequency. As shown in FIG. 9 and the associated text, the capacitors Cp, Cp′ are tunable over a range of values to select the even mode resonant frequency and the odd mode resonant frequency. Capacitors Cs are also tunable over a range of values to adjust the odd mode frequency (See, e.g., FIG. 8). Thus, dual-band oscillator device 10 provides a predetermined band of even mode resonant frequencies and a predetermined band of odd mode frequencies that may form a continuous band of tunable frequencies.

The active networks 16, 16′ comprise two PFET pairs 16 that are configured to start and sustain oscillation in the resonator. The differential voltage outputs across capacitors Cp, Cp′ (V+/−; V′+/−) are fed back to the gates of their respective PFET pair 16 to compensate for resonator 101 energy loss and sustain oscillation. Again, each LC tank (12, 12′) in general, and each PFET pair 16, 16′ in particular, is configured to provide a dual-band LO differential output signal (i.e., V+/−, and V′+/−).

The mode selection feedback network 18 is a switching network that is used to select between an even switch mode corresponding to the even mode resonant frequency and an odd switch mode corresponding to the odd mode resonant frequency. In the even switch mode, the differential signal (V+/−) and the differential signal (V′+/−) are in-phase and characterized by the even mode resonant frequency; and in the odd switch mode, the differential signals (V+/−, and V′+/−) are 180° out of phase and characterized by the odd mode resonant frequency.

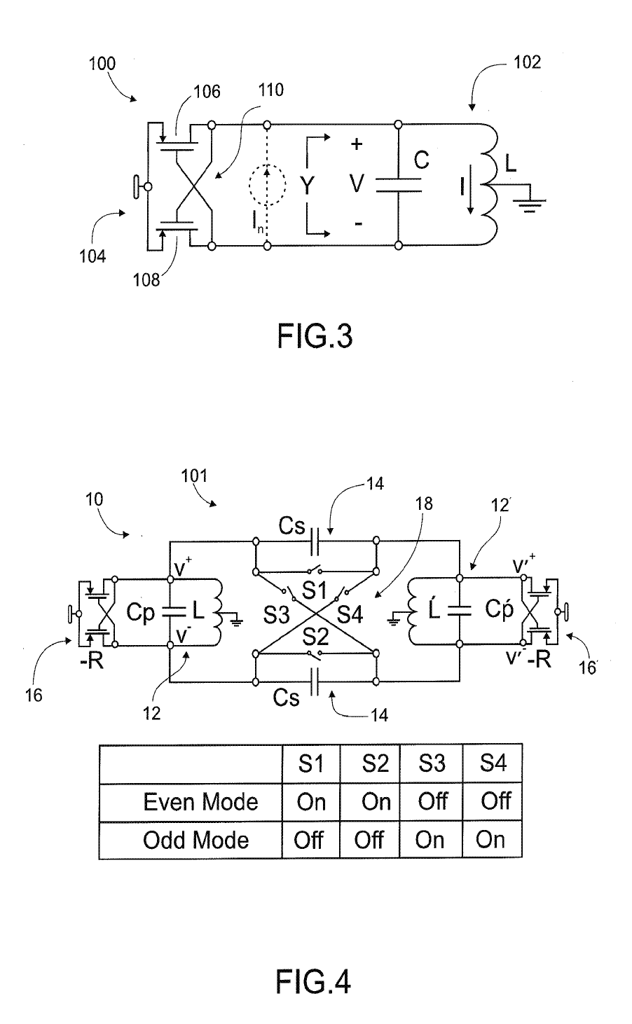

The switching network 18 includes four switches (S1-S4). The even mode is selected when switches S1 and S2 are closed and switches S3 and S4 are open. The odd mode is selected when switches S3 and S4 are closed and switches S1 and S2 are open. Unlike conventional switched-resonator designs, there is no current conducted through the switches during steady oscillation since the switches that are turned ON are only configured to damp the undesired mode. As a result, the working-mode quality factor of the resonator is not affected by the switches, and the oscillator achieves low-phase noise. Analysis shows that the dual-band oscillator 10 achieves the same phase-noise figure-of-merit (FoM) as a single-band LC oscillator that uses the same inductor and active core (FIG. 3). The FoM is defined as,

$$FoM = 10 {log}_{10} [ \frac{1}{{P}_{diss \vert m W}} {( \frac{{f}_{0}}{Δ f} )}^{2} ] - L ( Δ f ) , \qquad ( 1 )$$

in which f₀ is the center frequency, Δf is the offset frequency, L(Δf) is the phase noise in dBc/Hz, and P_{diss|mW} is the power consumption in mW. This analysis was verified by a prototype implemented using a 0.13 μm CMOS process. Stated briefly, when compared to a conventional single-band LC oscillator that used the same inductor and active core, the dual-band oscillator prototype achieved a phase noise that was 3 dBc/Hz lower than the phase noise of the conventional oscillator, while consuming 3 dB more power.

Theoretically, phase noise should scale down as 1/N if N oscillators are ideally coupled. However, coupling N oscillators is far from trivial in real circuit design. However, the proposed dual-band oscillator demonstrates the first ideally-coupled structure with band switching capability. Compared to the conventional two-oscillator scheme mentioned in the Background of the Invention, the proposed dual-band oscillator can be considered as two capacitively-coupled oscillators that achieve 3 dBc/Hz lower phase noise. The two inductors in LC oscillator 10 are never idle, and thus, they are better utilized to enhance phase noise than in the conventional two-oscillator scheme.

Moreover, the proposed dual-band structure 10 provides a new and improved way of trading power for phase noise that cannot be implemented using a conventional single-tank LC oscillator. As noted above, a single-tank LC oscillator achieves the power vs. phase noise trade-off by halving the tank impedance and doubling the power consumption; this approach lowers the phase noise by half. In contrast, the dual-band oscillator 10 of the present invention (FIG. 4) reduces the phase noise by another 3 dBc/Hz without having to reduce the inductance to impractical values. Moreover, the band-switching capacity of the present invention eases the trade-off between phase noise and frequency tuning.

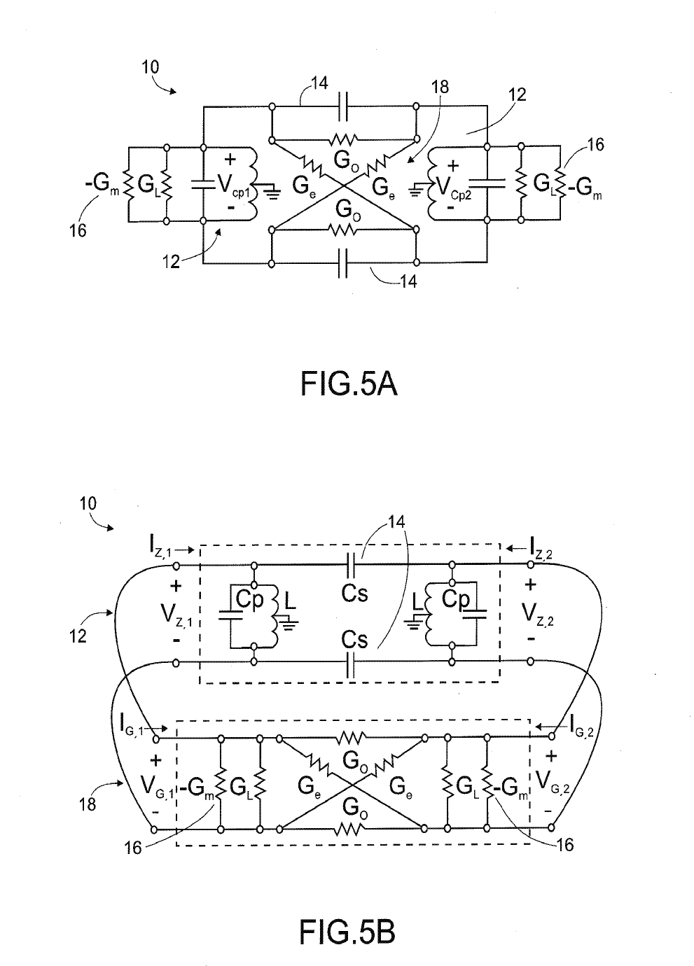

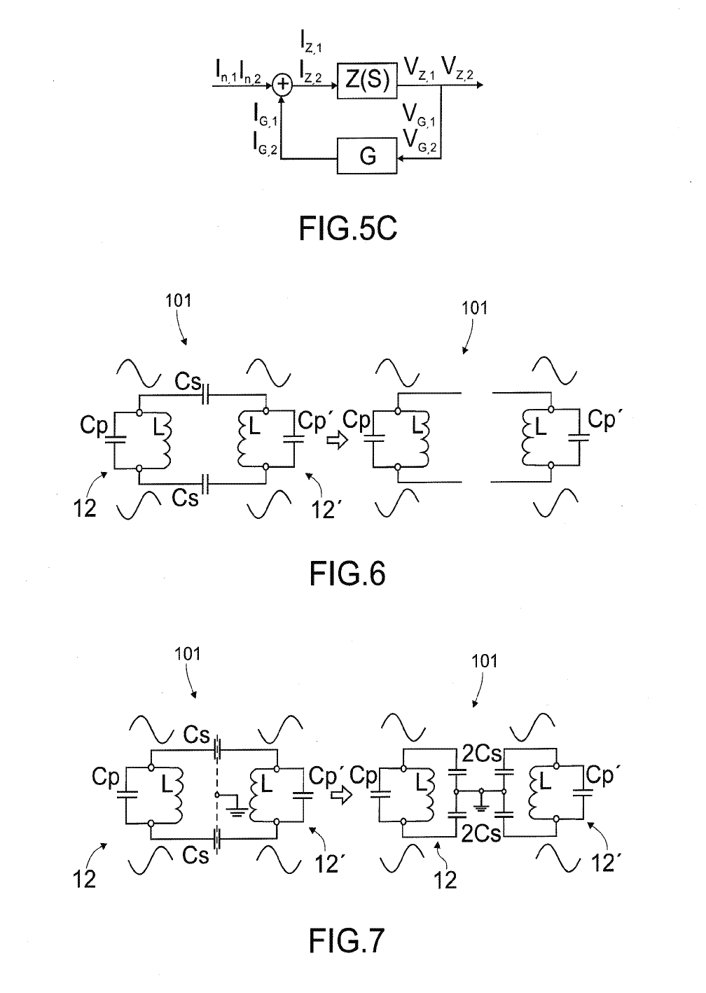

The operation of the dual mode oscillator is further described in reference to FIGS. 5A-5C. FIG. 5A models the dual-band oscillator 10 as a trans-conductance network. FIG. 5B leverages the trans-conductance network of FIG. 5A by modeling the dual-band oscillator 10 as a two-port network. FIG. 5C mathematically models the dual-band oscillator 10 as an LC resonator denoted as Z(s), and a trans-conductance network denoted as G. As shown in FIG. 5C, these two functional blocks form a feedback loop. The conditions of oscillation will be analyzed in detail using the feedback network models of FIGS. 5A-5C. However, before discussing FIGS. 5A-C in detail, a more intuitive approach is used to introduce the subject matter.

In reference to FIGS. 6 and 7, the even and odd resonant modes are introduced in an intuitive way. Because oscillator 10 employs center-taped symmetric inductors L and cross-connected differential PFET pairs (16, 16′) as an active core (shown in FIG. 4), the LC oscillator 10 works differentially. That is, the voltages (V+, V−) at the opposite terminals of capacitor Cp and inductor L are opposite in sign. Accordingly, only the resonator's differential modes are of interest. As noted, the resonator 101 has two resonant modes, an even mode and an odd mode. In the even mode, the two LC tanks 12, 12′ resonate in phase, i.e. V_{Cp}=V_{Cp′}. As illustrated in FIG. 6, the capacitors Cₛ see a zero voltage drop and do not carry current. Thereby, the resonator 101 can be reduced to two LC tanks separated by an open circuit. The resonant frequency is easily found to be

$${ω}_{e} = \frac{1}{\sqrt{{LC}_{p}}} , \qquad ( 2 )$$

in which the subscript e stands for “even mode”.

In the odd mode, the two LC tanks (12, 12′) are 180° out of phase, i.e. V_{Cp}=−V_{Cp′}. As illustrated in FIG. 7, the capacitor Cₛ sees a differential voltage at both of its terminals such that a virtual ground is established at the center of Cₛ; and the equivalent circuit on the right side of FIG. 7 is obtained. Thus, the resonant frequency is easily found to be,

$${ω}_{o} = \frac{1}{\sqrt{L ( {C}_{s} + {C}_{p} )}} , \qquad ( 3 )$$

in which the subscript o stands for “odd-mode”.

Turning to back to FIG. 5B, the dual-band oscillator 10 may be completely described as a two-port network. The model uses the impedance matrix (Z matrix), i.e.

$$\begin{matrix}[ \begin{matrix}{V}_{Z , 1} ( s ) \\ {V}_{Z , 2} ( s )\end{matrix} ] = Z ( s ) \cdot [ \begin{matrix}{I}_{Z , 1} ( s ) \\ {I}_{Z , 2} ( s )\end{matrix} ] , & ( 4 ) \\ Z ( s ) = \frac{1}{2} [ \begin{matrix}\begin{matrix}\frac{s}{{C}_{p} ( {s}^{2} + {w}_{e}^{2} )} + \\ \frac{s}{( {C}_{p} + {C}_{s} ) ( {s}^{2} + {ω}_{o}^{2} )}\end{matrix} & \begin{matrix}\frac{s}{{C}_{p} ( {s}^{2} + {ω}_{e}^{2} )} - \\ \frac{s}{( {C}_{p} + {C}_{s} ) ( {s}^{2} + {ω}_{o}^{2} )}\end{matrix} \\ \begin{matrix}\frac{s}{{C}_{p} ( {s}^{2} + {ω}_{e}^{2} )} - \\ \frac{s}{( {C}_{p} + {C}_{s} ) ( {s}^{2} + {ω}_{o}^{2} )}\end{matrix} & \begin{matrix}\frac{s}{{C}_{p} ( {s}^{2} + {ω}_{e}^{2} )} + \\ \frac{s}{( {C}_{p} + {C}_{s} ) ( {s}^{2} + {ω}_{o}^{2} )}\end{matrix}\end{matrix} ] . & ( 5 )\end{matrix}$$

The two resonant frequencies are clearly shown by the two terms of each matrix element. For instance, the impedance looking into Port 1 when Port 2 is open, i.e. |Z₁₁(jω)|, has two peaks, at ωₑ and •ₒ respectively.

The impedance looking into Port 1 is plotted in FIG. 8 and FIG. 9. As expected, there are two peaks in each curve, corresponding to the odd and the even mode, respectively. The frequencies of the peaks are correspond to those predicted by equations (2) and (3). In FIG. 8, when Cₛ increases, the odd mode frequency ω₀ decreases; however, the even mode frequency ωₑ is not affected. In FIG. 9, when Cₚ increases, both ωₒ and ωₑ decrease. It is worth mentioning again that the two frequencies are not harmonically related, and their ratio ωₑ/ωₒ=\sqrt{1+Cs/Cp} is determined by Cₛ/Cₚ.

Referring back to FIG. 5A, a trans-conductance network may be employed to model all energy-loss and energy-compensation components in the oscillator. In particular, G_{L} is the parallel conductance of the resonator 101, and models the energy loss of the passive components; −Gₘ is the negative conductance of the differential pairs (16, 16′); Gₒ is the conductance of switches S₁ and S₂ shown in FIG. 4; and Gₑ is the conductance of switches S₃ and S₄ depicted in FIG. 4. Note that when a switch is turned OFF, its conductance G₀ or Gₑ is zero; when it is turned ON, G₀ or Gₑ is a positive value G_{o,on} or G_{e,on}. Putting everything together, the two-port network shown in FIG. 5B is obtained, which is described by,

$$\begin{matrix}[ \begin{matrix}{I}_{G , 1} \\ {I}_{G , 2}\end{matrix} ] = G \cdot [ \begin{matrix}{V}_{G , 1} \\ {V}_{G , 2}\end{matrix} ] , & ( 6 ) \\ G = [ \begin{matrix}- {G}_{m} + {G}_{L} + \frac{1}{2} {G}_{o} + \frac{1}{2} {G}_{e} & - \frac{1}{2} {G}_{o} + \frac{1}{2} {G}_{e} \\ - \frac{1}{2} {G}_{o} + \frac{1}{2} {G}_{e} & - {G}_{m} + {G}_{L} + \frac{1}{2} {G}_{o} + \frac{1}{2} {G}_{e}\end{matrix} ] . & ( 7 )\end{matrix}$$

Interestingly, this network also shows even and odd mode operations. That is, if applying even voltage to the two ports, i.e. V_{G,1}=V_{G,2}=V₀, we get I_{G,1}=I_{G,2}=(−Gₘ+G_{L}+Gₑ)·V₀. Thus, each port sees an effective conductance of (−Gₘ+G_{L}+Gₑ); if applying odd voltage V_{G,1}=−V_{G,2}, each port sees an effective conductance of (−Gₘ+G_{L}+G₀). As a result, the even mode and odd mode of the LC resonator experience different energy loss and energy compensation; this fact is used by the present invention to realize mode/frequency switching.

Based on above discussion and the mathematical model in FIG. 5C, the response of the oscillator to noise current [I_{n,1}, I_{n,2}] is derived as being equal to,

$$\begin{matrix}[ \begin{matrix}{V}_{Z , 1} ( s ) \\ {V}_{Z , 2} ( s )\end{matrix} ] = {Z ( s ) [ I + Z ( s ) G ]}^{- 1} \cdot [ \begin{matrix}{I}_{n , 1} ( s ) \\ {I}_{n , 2} ( s )\end{matrix} ] \\ = {H}_{e} ( s ) \frac{{I}_{n , 1} ( s ) + {I}_{n , 2} ( s )}{2} [ \begin{matrix}1 \\ 1\end{matrix} ] + {H}_{o} ( s ) \\ \frac{{I}_{n , 1} ( s ) - {I}_{n , 2} ( s )}{2} [ \begin{matrix}1 \\ - 1\end{matrix} ] ,\end{matrix} \qquad ( 8 )$$

in which

$$\begin{matrix}{H}_{e} ( s ) = \frac{1}{{C}_{p}} \cdot \frac{s}{{s}^{2} - \frac{{G}_{m} - {G}_{L} - {G}_{e}}{{C}_{p}} s + {ω}_{e}^{2}} , & ( 9 ) \\ {H}_{o} ( s ) = \frac{1}{{C}_{p} + {C}_{s}} \cdot \frac{s}{{s}^{2} - \frac{{G}_{m} - {G}_{L} - {G}_{o}}{{C}_{p} + {C}_{s}} s + {ω}_{o}^{2}} . & ( 10 )\end{matrix}$$

From equation (8), note that even mode noise can stimulate oscillation at ωₑ with transfer function Hₑ(s), and odd mode noise can stimulate oscillation at ωₒ with transfer function Hₒ(s). Since random noise has both even and odd mode components, the question of whether a mode can start up is determined by its respective transfer function, Hₑ(s) or Hₒ(s). In even mode oscillation, switches S₁ and S₂ are ON, and switches S₃ and S₄ are OFF. Thus, Gₑ=0 and Gₒ=G_{o,on}>0. Accordingly, the transistors are sized such that:

G_{o,on}>Gₘ−G_{L}>0, (11)

Arranging the terms, Gₘ−G_{L}−Gₑ>0 and Gₘ−G_{L}−Gₒ<0. In this case, the even mode transfer function Hₑ(s) has its poles pₑ on the right-half plane, while the odd mode transfer function Hₒ(s) has its poles pₒ on the left-half plane. Therefore, only the even mode can start up. In odd mode oscillation, switches S₁ and S₂ are turned OFF and switches S₃ and S₄ are turned ON. Thus, Gₑ=G_{e,on}>0 and Gₒ=0. The transistors are sized such that

G_{o,on}>Gₘ−G_{L}>0, (12)

Again arranging the terms, Gm−G_{L}−Ge, 0 and Gm−G_{L}−Go>0. In this case, Hₑ(s) has its poles on the left-half plane, while Hₒ(s) has its poles on the right-half plane. Therefore, only the odd mode can start up and be sustained.

In summary, the transistors should be sized such that

G_{e,on}, G_{o,on}>Gₘ−G_{L}>0, (13)

to guarantee that the desired oscillation mode will start-up while the other mode is damped. In other words, if the PFET transistors (16, 16′) are sized accordingly, frequency switching will be enabled.

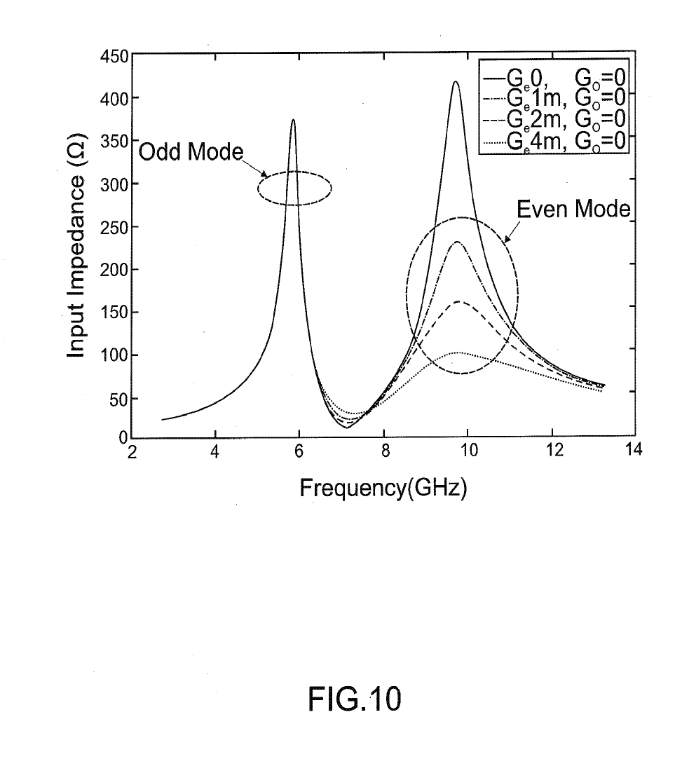

In reference to FIG. 10, it is worth noting that Ge and Go damp the unwanted mode, but do not degrade the working mode quality factor. Taking the odd mode oscillation as an example (i.e., wherein Gₑ=G_{e,on}>0 and Gₒ=0), the input impedance of the resonator 101 was simulated, with Gₘ=Gₒ=0; and Gₑ was varied over a range from 0 to 0.004Ω⁻¹. As illustrated in FIG. 10, Gₑ lowers the even-mode peak, but does not affect the height or width of the odd-mode peak. Intuitively, the even mode component imposes a voltage drop across Gₑ and thus its energy is dissipated, but the odd mode component does not see Gₑ and is therefore not affected.

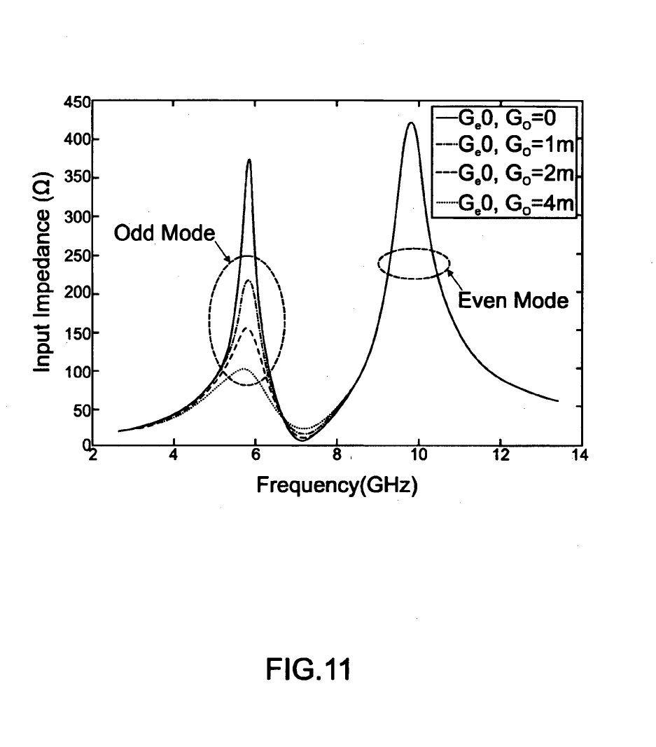

Even mode oscillation is illustrated in FIG. 11. When Gₒ=G_{o,on}>0 only the odd mode is damped; the even mode is unaffected. Thus, the dual-band oscillator 10 should exhibit excellent phase noise characteristics. And this is verified by a rigorous analysis of phase noise which is provided after a discussion of the extended tuning range of the present invention.

As noted above, the dual-oscillator 10 depicted in FIG. 4 features an extended tuning range when compared to conventional single band LC VCO devices. For example, in conventional single-band LC VCO devices, switched capacitor banks are often used for course tuning and varactors are used for fine tuning. However, due to the trade-offs between switch loss and parasitic capacitance, Cₘₐₓ/Cₘᵢₙ is relatively small. For instance, a design with a continuous tuning range of 3.1 GHz-5.2 GHz corresponds to a Cₘₐₓ/Cₘᵢₙ of 2.8. This ratio includes parasitic capacitances from the active core and loading etc. In comparison, the present invention (FIG. 4) offers an extended tuning range vis á vis the conventional design.

As noted previously, the dual-band oscillator 10 may be tuned using capacitors Cp, Cp′. If Cₚ is implemented as a switched capacitor and varactor with a tuning range between Cₘₐₓ and Cₘᵢₙ; and Cₛ is implemented as a fixed capacitor (see, e.g., FIG. 9), the odd switch mode will cover a low frequency band from 1/\sqrt{L(Cₘₐₓ+Cₛ)} to 1/\sqrt{L(Cₘᵢₙ+Cₛ)}, and the even switch mode will cover a high frequency band from 1/\sqrt{LCₘₐₓ} to 1/\sqrt{LCₘᵢₙ}. Since the switches S1-S4 do not affect the working mode quality factor, they do not need to be implemented as extremely wide transistors and thus do not introduce significant parasitic capacitance. If Cₘₐₓ=2.6 C₀, Cₘᵢₙ=C₀ and Cₛ=1.5 C₀, the even and odd bands have a considerable overlap and cover a continuous tuning range with fₘₐₓ/fₘᵢₙ>2. In one embodiment of the present invention, the dual-band oscillator 10 is implemented with an 8-bit course tuning bank and varactors in a 65 nm CMOS technology. The odd switch mode of this embodiment covers a 2.4 GHz-3.2 GHz band of frequencies, whereas the even band covers a range of frequencies between 3 GHz-5 GHz. In contrast, a similar tuning range in conventional single-band VCO designs requires Cₘₐₓ/Cₘᵢₙ>4, which is hardly possible.

Phase noise is a primary concern in oscillator design and the present invention demonstrates a 3 dBc/Hz phase noise improvement over conventional oscillators. Existing phase noise theories mainly fall into two categories, i.e., frequency-domain and time-domain theories. The present analysis is based on the impulse sensitivity function (ISF) theory.

With reference to the single-band LC oscillator shown in FIG. 3, if a noise current pulse iₙ=δ(t−τ) is injected into the LC tank at t=τ, there is a voltage increase of ΔVₛ=1/C. This voltage increase induces a phase shift Δ(τ), which depends on the LC tank's state at t=τ, and thus varies at the same frequency as the oscillator. Δ(τ) is actually the ISF function, and describes the time-variant phase response to noise. For oscillators with high-Q LC resonators, the ISF can be well approximated by a sinusoidal function at the same frequency as the oscillator. Assuming the oscillation swing is Vp, the amplitude of ISF is:

$${\vert ISF \vert}_{single} = \vert \frac{Δ {V}_{s}}{{V}_{p}} \vert = \frac{1}{C \cdot {V}_{p}} . \qquad ( 14 )$$

The dual-band oscillator 10 (FIG. 4) exhibits a considerable improvement over the conventional single band LC oscillator. Taking odd mode oscillation as an example, if a noise current pulse is injected for I_{n,1} (or I_{n,2}), the induced odd-mode voltage increase is ΔV₀=½(Cₚ+Cₛ). Although the current pulse also induces an even mode component, it decays rapidly and does not change the phase of the odd-mode oscillation in a first-order estimate. Thus, assuming the oscillation swing is Vₚ and using the same reasoning as employed in the single-band oscillator analysis, the amplitude of ISF is

$${\vert ISF \vert}_{odd} = \vert \frac{Δ {V}_{o}}{{V}_{p}} \vert = \frac{1}{2 ( {C}_{p} + {C}_{s} ) \cdot {V}_{p}} . \qquad ( 15 )$$

If the two oscillators use the same L and are at the same frequency, it follows that C=Cₛ+Cₚ. If that also use the same active core and supply voltage, they should have the same voltage swing Vₚ. Therefore, it further follows that:

|ISF|_{odd}=½|ISF|_{single}. (16)

Intuitively, this result can be explained by the fact that, in the dual-mode oscillator, only half of the injected current pulse induces the odd-mode voltage that perturbs the oscillation phase. The other half of the injected current pulse induces the even-mode component, which is damped by the circuit, such that it does not perturb the oscillation phase.

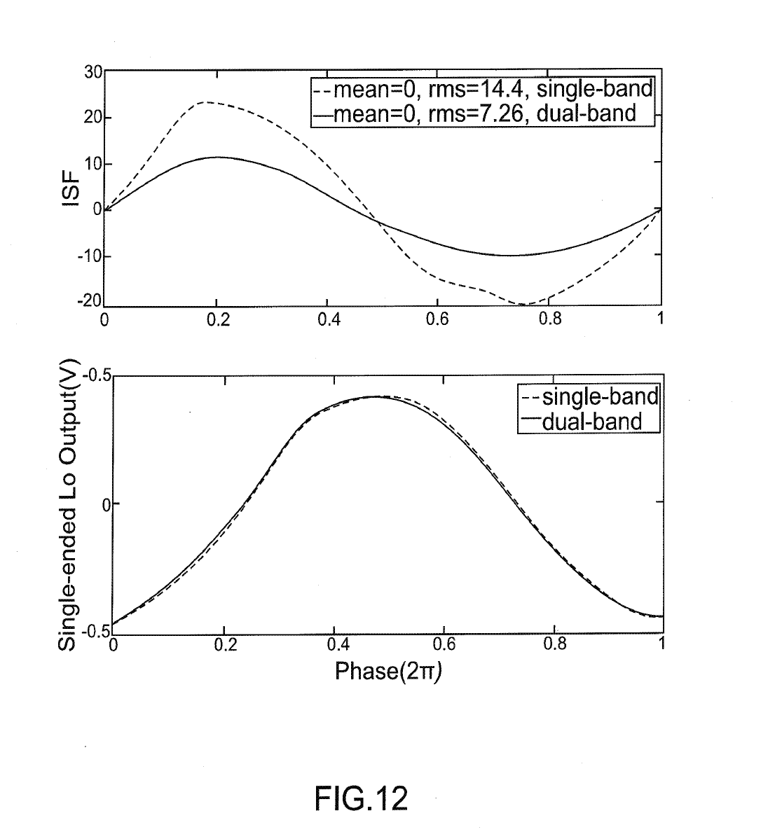

FIG. 12 is a plot comparing the ISF and voltage waveforms of a single band LC oscillator with those of the dual-band oscillator 10 of the present invention. The conventional single-band oscillator and the dual-band LC oscillator 10 of the present invention were implemented using a 0.13 μm CMOS process to verify the theoretical results provided immediately above. The simulation was performed with SpectreRF. The two oscillators employed the same inductor and active core, and the capacitors were tuned such to the same frequency 5.39 GHz. The voltage swings are the same for the two oscillators, and V_{DD}=0.5 V; both designs operate only in the voltage-limited region. The ISFs are at the same frequency as the voltages, and the phase is shown to be most sensitive to noise at voltage zero-crossings. The root-mean-square (rms) values are calculated as the amplitudes of the ISF curves. The ISF of the dual-band oscillator is exactly half of the amplitude of the single-band oscillator. The results are the same for the dual-band oscillator's even mode, provided the single-band oscillator is set to the same frequency. For brevity's sake, the discussion of the even mode is not repeated here.

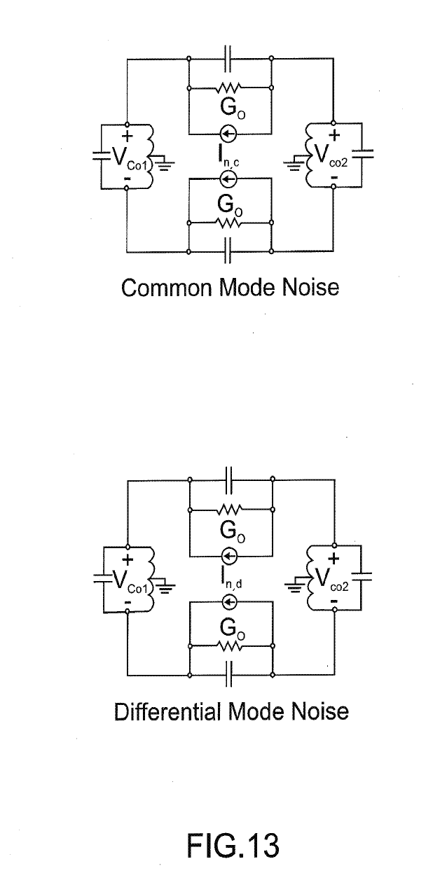

In reference to FIG. 13, an illustration of switch noise in even mode oscillation is depicted. The convention single band LC oscillator and the dual-band oscillator 10 of the present invention have common noise sources in the active cores and the inductors. However, the switches in the dual-band oscillator introduce extra noise and therefore require careful consideration. The schematic provided in FIG. 13 uses even switch mode oscillation as an example. Note that switches S₁ and S₂ are ON in the even mode oscillation (FIG. 4), and they insert two non-zero conductors Gₒ (FIG. 13). The noise of the two conductors Gₒ can be modeled as two current sources, which can always be decomposed into its common-mode and differential-mode components. The common-mode noise is damped by the active cores and the center-tapped symmetric inductors. The differential-mode noise leads to an odd mode component in the resonator, which is damped by conductors Gₒ. In other words, in even mode oscillation, although the two conductors Gₒ generate noise, they do not add any even mode component to the resonator and thus do not perturb the phase of oscillation. The analysis of odd mode oscillation is similar.

Table I compares the phase noise contributions from various parts of each oscillator circuit. The switching network accounts for only 0.9% of the total noise and is thus negligible in phase noise analysis.

TABLE I
SIMULATED PHASE NOISE CONTRIBUTION AT Δf = 1 MHz

| | Single-band | Dual-band |
|---|---|---|
| active core | 69.6% | 66.9% |
| inductor | 22.3% | 22.7% |
| capacitor | 6.1% | 5.8% |
| switches | N/A | 0.9% |
| others | 2% | 3.7% |

According to the ISF theory of phase noise, the phase noise induced by a noise source is proportional to the square of its ISF's amplitude. Based on the ISF comparison in equation (16), the phase noise of the dual-band oscillator due to one active core 16 and/or one inductor L is (½)², or one fourth (¼) that of the single-band oscillator. But the dual-band oscillator has two active cores (16, 16′), which introduces twice the noise when compared to the single-band oscillator. Therefore, the total phase noise of the dual-band oscillator is 2×(¼)=½ of the single-band one, which represents a 3 dBc/Hz improvement. Moreover, because the dual-band oscillator has two active cores (16, 16′), it consumes twice the power of the single-band oscillators. Therefore, we conclude the dual-band and the single-band oscillators have the same FOM, as defined in equation (1).

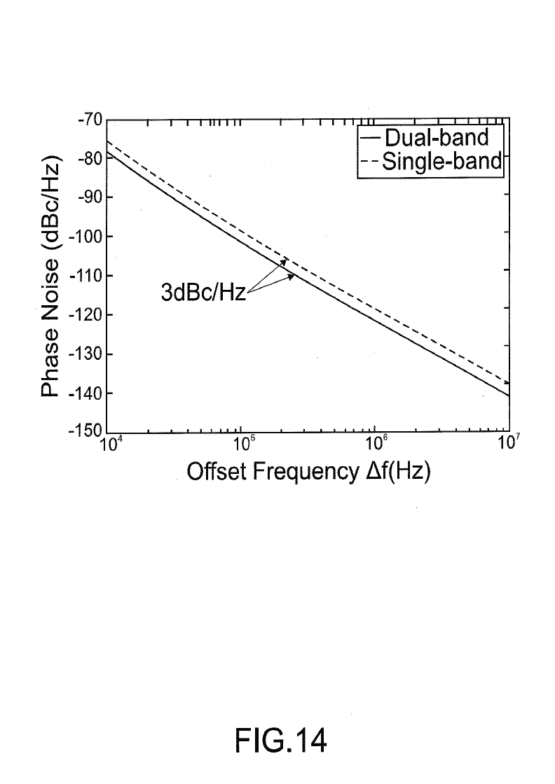

In reference to FIG. 14, a plot of simulated phase noises is provided. In this simulation, the conventional single-band oscillator and the dual-band oscillator 10 of the present invention drew a current of 2 mA and 4 mA, respectively, from a 0.5 V power supply. The dual-band oscillator 10 was switched into the odd mode, and the conventional single-band oscillator was tuned to the odd mode frequency. As expected, the dual-band oscillator 10 shows 3 dBc/Hz lower phase noise than the conventional single-band oscillator. The same result also holds for the dual-band oscillator 10 working in the even mode as long as the conventional single-band oscillator is tuned to the same frequency.

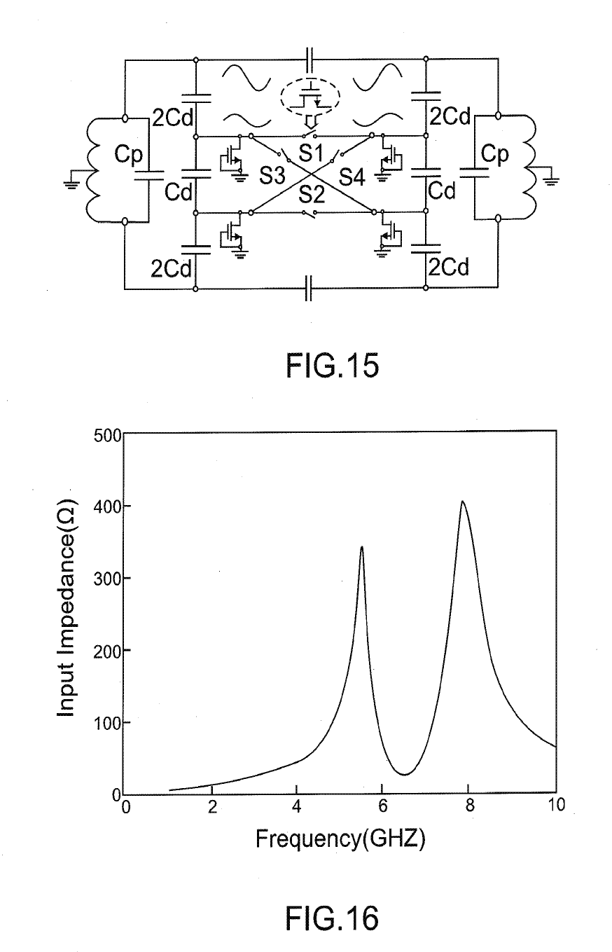

As embodied herein and depicted in FIG. 15, an alternate embodiment of the present invention is disclosed. Briefly stated, a capacitive voltage divider (comprising capacitors Cd) is employed such that half of the voltage swing is present at the switch transistors (S1-S4). In this embodiment, leakage current that may result from larger voltage swings presented to the switches is substantially eliminated. Meanwhile, the switch transistors (W/L=40 μm/0.12 μm) provide the same damping effect provided by the embodiment of FIG. 4. In yet another embodiment of the present invention, a CMOS active core may be used instead of a PMOS active core as a means to limit or avoid leakage current.

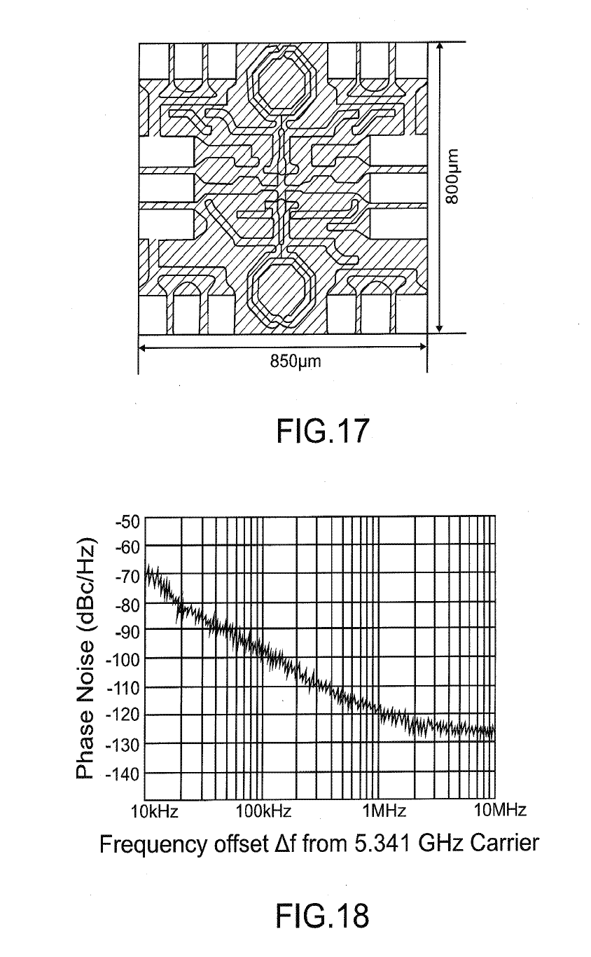

FIG. 16 is a plot showing the input impedance of dual-mode LC resonator 10 implemented in accordance with the embodiment of FIG. 4. In this embodiment, the dual band resonator is loaded with the active core (16, 16′) and switch network 18. FIG. 17 shows the die photo of the dual-band oscillator 10.

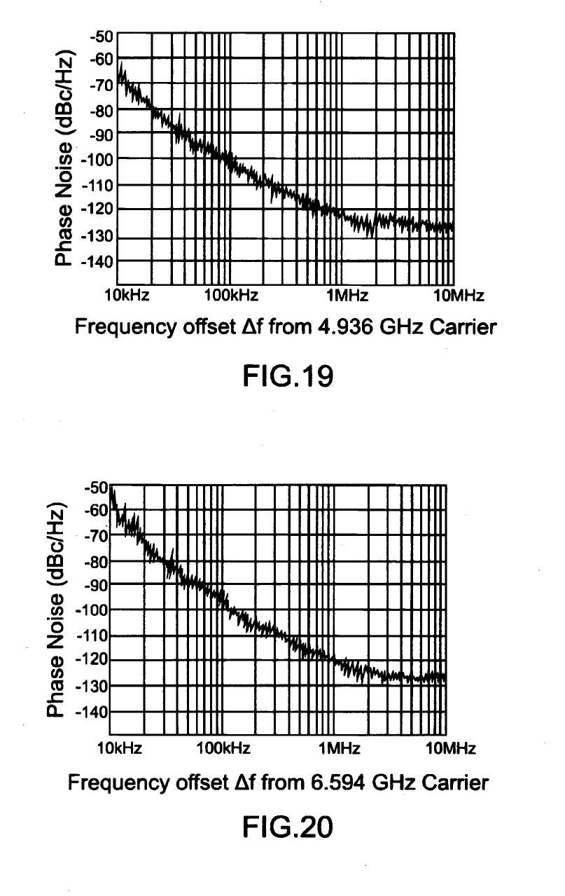

FIG. 18 is a plot showing the phase noise of a convention single band design. FIG. 19 is a plot showing the measured phase noise of the odd mode of the dual-band oscillator 10 and FIG. 20 is a plot showing the measured phase noise of the even mode of the dual-band oscillator 10. Both the dual-band oscillator 10 (See, e.g., FIG. 4) and the conventional design were implemented using 0.13 μm CMOS technology with 0.5 V power supply, As shown in FIGS. 18-20, both designs were implemented to verify switching functionality and phase noise analysis. Both designs employ the same PFET pair (W/L=72 μm/0.12 μm) and the same center-taped symmetric inductor (1.138 nH). Metal-insulator-metal (MIM) capacitors were also employed, the values of which are set such that the oscillators operate at the desired frequencies. Both the dual-band oscillator 10 of the present invention and the conventional single band oscillator were measured with an Agilent 8564EC spectrum analyzer.

Table II and Table III summarize and compare results from simulation and measurement. Although the measured frequencies of both oscillators drop due to parasitics, the measure phase noise agrees well with simulation. Moreover, the frequency of the dual-band oscillator 10 decreases more than that of the conventional single-band oscillator. This result can be explained by the parasitics of the long metal traces between the two inductors.

In terms of phase noise, the single-band oscillator is tuned to about the same frequency as the odd mode of the dual-band oscillator. As expected, both simulation and measurement show the 3 dBc/Hz phase noise improvement of the dual-band oscillator, compared to the single-band oscillator. While the dual-band oscillator consumes twice the power of the conventional single-band device, the two oscillators have the same phase-noise FoM, which verifies the analysis presented herein. The even mode oscillates at a higher frequency and its FoM is about 2 dB lower than the odd mode, largely because of the drop in the resonator's Q.

TABLE II
SUMMARY OF SIMULATION RESULTS

| | | Dual-band | Dual-band |
|---|---|---|---|
| | Single-band | Odd Mode | Even Mode |
| V_{DD} (V) | 0.50 | 0.50 | 0.52 |
| I_{DC} (mA) | 1.97 | 3.98 | 4.05 |
| f₀ (GHz) | 5.479 | 5.390 | 7.583 |
| L(Δf) | −99.3@0.1 | −102.5@0.1 | −97.9@0.1 |
| (dBc/Hz | −115.3@0.6 | −118.5@0.6 | −114.0@0.6 |
| @MHz) | | | |
| FOM(Δf) | 194.1@0.1 | 194.1@0.1 | 192.3@0.1 |
| (dB@MHz) | 194.6@0.6 | 194.6@0.6 | 193.0@0.6 |

TABLE III
SUMMARY OF MEASUREMENT RESULTS

| | | Dual-band | Dual-band |
|---|---|---|---|
| | Single-band | Odd Mode | Even Mode |
| V_{DD} (V) | 0.504 | 0.506 | 0.510 |
| I_{DC} (mA) | 2.01 | 4.00 | 3.99 |
| f₀ (GHz) | 5.341 | 4.936 | 6.594 |
| L(Δf) | −98.3@0.1 | −102.3@0.1 | −97.7@0.1 |
| (dBc/Hz | −115.8@0.6 | −119.3@0.6 | −114.8@0.6 |
| @MHz) | | | |
| FOM(Δf) | 192.8@0.1 | 193.1@0.1 | 191.0@0.1 |
| (dB@MHz) | 194.7@0.6 | 194.5@0.6 | 192.5@0.6 |

In summary, the present invention is directed to a distribution dual-band oscillator 10 suitable for low-phase-noise applications. In contrast to other switched-resonator designs, there is actually no current going through the switches, which leads to low phase noise. The design and analysis were verified by a prototype implemented in a 0.13 μm CMOS process. There is excellent agreement between theory, simulation, and measurement results.

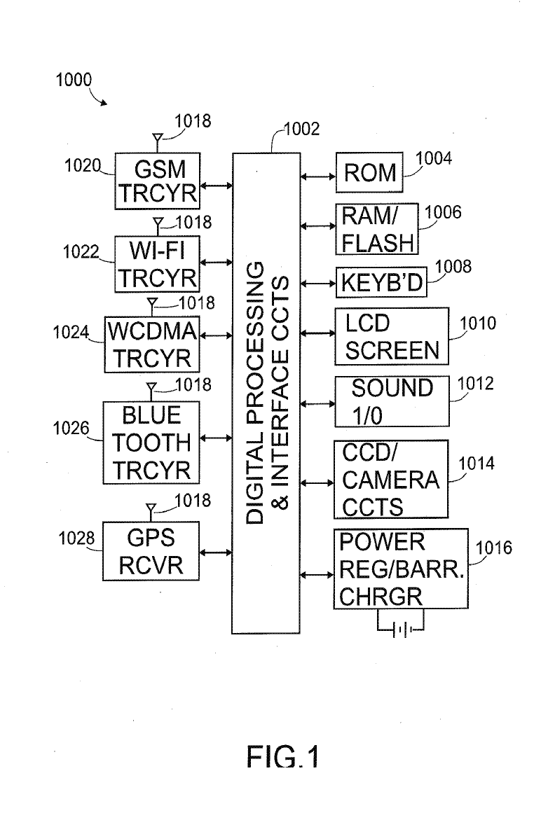

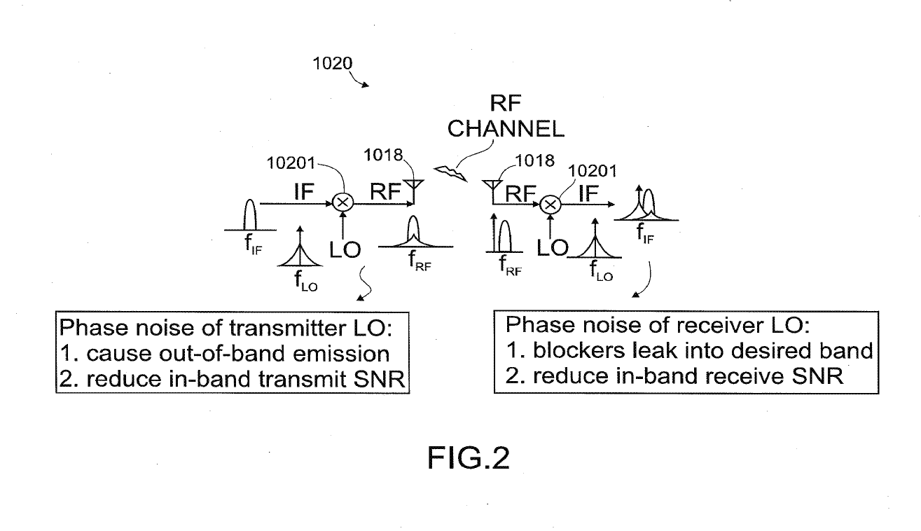

Use of various oscillators embodying the present invention will now be discussed. Wireless communication devices generally require the use of RF carrier signals for modulating or demodulating data. These RF carrier signals may be selectively buried over RF ranges (or bands), depending on the particular application and wireless communication scheme. Generally speaking, the carrier signal is supplied by a local oscillator (LO). However, the local oscillator must be capable of generating the full range of all bands that may be required for various carrier signals used by the wireless communication device. Also, the local oscillator uses energy. This energy consumption will often increase is multiple oscillators are required (to provide a wide effective bandwidth), or if the properties of a single resonator circuit are varied (again, to provide a wide bandwidth. Phase noise is also a potential problem. This is true in older generation cell phones, which were operated primarily as telephones. It is even more true for modem “smart phones,” which add computer capabilities to a “plain old cell phone.” The increased, useful functionality of smart phones leads to increased usage, increased power consumption, greater bandwidth requirements (for various types of transceivers built into a single smart phone). The oscillator circuits described herein can effectively increase bandwidth and/or reduce energy consumption—and this is true over a whole spectrum of wireless communication devices from 1990s era cell phones to the smart phones of today (and tomorrow). For example, an LO to serve the various transceivers of communication device 1000 (see FIG. 1) may be in the form of a chip that is made part of digital processing and interface circuits 1002 as shown in FIG. 1.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A resonator circuit comprising:
a first tank circuit configured to resonate at a first resonant frequency, the first tank circuit including a first differential output;
a second tank circuit configured to resonate at the first resonant frequency, the second tank circuit including a second differential output; and
a reactive network coupled to the first tank circuit and the second tank circuit such that the resonator circuit is configured to resonate at the first resonant frequency and at least one second resonant frequency, the first resonant frequency and the at least one second resonant frequency not being harmonically related.

2. The circuit of claim 1, wherein the first tank circuit includes a first tunable capacitor element disposed in parallel with a first inductor element, the value of the first tunable capacitor element and the value of the first inductor element substantially determining the first resonant frequency.

3. The circuit of claim 2, wherein the second tank circuit includes a second tunable capacitor element disposed in parallel with a second inductor element, the values of the second tunable capacitor element and the second inductor element being substantially equal to the values of the first tunable capacitor element and the first inductor element, respectively.

4. The circuit of claim 3, wherein the first tunable capacitor element and the second tunable capacitor element are tunable over a first range of capacitor values, the first tank circuit and the second tank circuit being tunable such that the first resonant frequency is selectable from a first predetermined band of frequencies and the at least one second resonant frequency is selectable from a second predetermined band of frequencies.

5. The circuit of claim 3, wherein the reactive network includes a plurality of third tunable capacitor components coupled to the first tunable capacitor element and the second tunable capacitor element, the plurality of third tunable capacitor components being tunable over a second range of capacitor values such that the at least one second resonant frequency is selectable from a second predetermined band of frequencies.

6. The circuit of claim 1, wherein the reactive network includes a plurality of tunable capacitor components configured to react with the first tank circuit and the second tank circuit, the plurality of tunable capacitor components being tunable over a range of capacitor values such that the at least one second resonant frequency is selectable from a second predetermined band of frequencies.

7. A communications system comprising:
a frequency selective resonator circuit including a first tank circuit being tunable to a first resonant frequency within a first predetermined band of frequencies, the first tank circuit including a first differential output, the frequency selective resonator circuit further including a second tank circuit also being tunable to the first resonant frequency within the at least one first predetermined band of frequencies, the second tank circuit including a second differential output, the frequency selective resonator circuit further including a reactive network coupled between the first tank circuit and the second tank circuit such that the frequency selective resonator circuit is configured to resonate at the first resonant frequency and at a second frequency within a second predetermined band of frequencies; and
an energy compensation network coupled to the frequency selective resonator circuit, the energy compensation network being configured to start and sustain oscillation in the frequency selective resonator circuit such that the first differential output provides a first differential signal and the second differential output provides a second differential signal.

8. The system of claim 7, wherein the first differential signal is characterized by a first differential signal component characterized by the first frequency and a second differential signal component characterized by the second frequency, the second differential signal being characterized by a third differential signal component characterized by the first frequency and a fourth differential signal component characterized by the second frequency, the first differential signal component and the third differential signal component being substantially in-phase, the second differential signal component and the fourth differential signal component being out of phase.

9. The circuit of claim 7, wherein the first tank circuit includes a first tunable capacitor element disposed in parallel with a first inductor element, the value of the first tunable capacitor element and the value of the first inductor element substantially determining the first resonant frequency, and wherein the second tank circuit includes a second tunable capacitor element disposed in parallel with a second inductor element, the values of the second tunable capacitor element and the second inductor element being substantially equal to the values of the first tunable capacitor element and the first inductor element, respectively.

10. The circuit of claim 9, wherein the first tunable capacitor element and the second tunable capacitor element are tunable over a first range of capacitor values, the first tank circuit and the second tank circuit being tunable such that the first resonant frequency is selectable from a first predetermined band of frequencies and the at least one second resonant frequency is selectable from a second predetermined band of frequencies.

11. The circuit of claim 9, wherein the reactive network includes a plurality of third tunable capacitor components coupled to the first tunable capacitor element and the second tunable capacitor element, the plurality of third tunable capacitor components being tunable over a second range of capacitor values such that the at least one second resonant frequency is selectable from a second predetermined band of frequencies.

12. The circuit of claim 7, wherein the reactive network includes a plurality of tunable capacitor components configured to react with the first tank circuit and the second tank circuit, the plurality of tunable capacitor components being tunable over a range of capacitor values such that the at least one second resonant frequency is selectable from a second predetermined band of frequencies.

13. The circuit of claim 7, wherein the at least one first predetermined band of frequencies and the at least one second predetermined band of frequencies comprise a continuous band of tunable frequencies.

14. A communications system comprising:
a frequency selective resonator circuit including a first tank circuit characterized by a predetermined phase noise parameter and a second tank circuit characterized by the predetermined phase noise parameter, the first tank circuit being tunable to a first resonant frequency within a first predetermined band of frequencies, the first tank circuit including a first differential output, the second tank circuit also being tunable to the first resonant frequency within the at least one first predetermined band of frequencies, the second tank circuit including a second differential output, the frequency selective resonator circuit further including a reactive network coupled between the first tank circuit and the second tank circuit such that the frequency selective resonator circuit is configured to resonate at the first resonant frequency and at a second frequency within a second predetermined band of frequencies;
an energy compensation network coupled to the frequency selective resonator circuit, the energy compensation network being configured to start and sustain oscillation in the frequency selective resonator circuit such that the first differential output provides a first differential signal and the second differential output provides a second differential signal; and
a mode selection network coupled to the reactive network and the frequency selective resonator circuit, the mode selection network being switchable between a first switch mode and a second switch mode, the first differential signal and the second differential signal being in-phase and characterized by the first frequency in the first switch mode, the first differential signal and the second differential signal being out of phase and characterized by the second frequency in the second switch mode.

15. The system of claim 14, wherein the at least one first predetermined band of frequencies and the at least one second predetermined band of frequencies comprises a continuous band of tunable frequencies.

16. The system of claim 14, wherein the first tank circuit includes a first tunable capacitor element disposed in parallel with a first inductor element, the value of the first tunable capacitor element and the value of the first inductor element substantially determining the first resonant frequency, and wherein the second tank circuit includes a second tunable capacitor element disposed in parallel with a second inductor element, the values of the second tunable capacitor element and the second inductor element being substantially equal to the values of the first tunable capacitor element and the first inductor element, respectively.

17. The system of claim 16, wherein the first tunable capacitor element and the second tunable capacitor element are tunable over a first range of capacitor values such that the first resonant frequency is selectable from the first predetermined band of frequencies and the second resonant frequency is selectable from the second predetermined band of frequencies.

18. The system of claim 16, wherein the reactive network includes a plurality of third tunable capacitor components coupled to the first tunable capacitor element and the second tunable capacitor element, the plurality of third tunable capacitor components being tunable over a second range of capacitor values such that the second resonant frequency is selectable from the second predetermined band of frequencies.

19. The system of claim 14, wherein the reactive network includes a plurality of tunable capacitor components configured to react with the first tank circuit and the second tank circuit, the plurality of tunable capacitor components being tunable over a range of capacitor values such that the second resonant frequency is selectable from a second predetermined band of frequencies.

20. The system of claim 14, wherein the electrical current propagating between the first tank circuit and the second tank circuit is substantially equal to zero when the frequency selective resonator circuit is in oscillation.

21. The system of claim 14, wherein the mode selection network is arranged to configure the reactive network as a virtual open circuit between the first tank circuit and the second tank circuit in the first switch mode.

22. The system of claim 14, wherein the mode selection network is arranged to configure the reactive network as a virtual ground between the first tank circuit and the second tank circuit in the second switch mode.

23. The system of claim 14, wherein the mode selection network is arranged to configure the reactive network in the second switch mode such that a capacitor element is placed in parallel with the first tank circuit and a capacitor element is placed in parallel with the second tank circuit.

24. The system of claim 14, wherein the system is substantially characterized by the predetermined phase noise parameter.

25. The system of claim 14, wherein the reactive network includes a first capacitor element coupled between a first port of the first differential output and a first port of the second differential output, the reactive network further including a second capacitor element coupled between a second port of the first differential output and a second port of the second differential output.

26. The system of claim 25, wherein the mode selection network includes a plurality of switch elements coupled between the first capacitor element and the second capacitor element.

27. The system of claim 26, wherein the plurality of switch elements includes a first switch element disposed in parallel with the first capacitor element and a second switch element disposed in parallel with the second capacitor element, the plurality of switch elements including a third switch element coupled between an anode of the first capacitor element and a cathode of the second capacitor element and a fourth switch element coupled between an cathode of the first capacitor element and an anode of the second capacitor element.

28. The system of claim 27, wherein the first switch element and the second switch element are closed in the first switch mode, the third switch element and the fourth switch element being closed in the second switch mode.

29. The system of claim 27, wherein the first switch element and the second switch element are open in the second switch mode, the third switch element and the fourth switch element being open in the first switch mode.

30. The system of claim 26, wherein the mode selection network includes a voltage divider network coupled to the plurality of switch elements.

31. The system of claim 30, wherein the voltage divider network includes a plurality of capacitor elements.

32. A method of controlling the flow of electricity, the method comprising the following steps:
providing an oscillator circuit comprising a band switching portion, a resonator portion and a set of output terminals, with: (i) the band switching network, the resonator portion and the set of output terminals being operatively electrically coupled to each other, (ii) the band switching portion comprising a set of switch(es) and (iii) the band switching portion being configurable between at least a first configuration and a second configuration;
selectively supplying electrical energy to the resonator portion in order to cause resonation in the resonator portion; and
configuring the set of switch(es) of the band switching potion so that: (i) when the band switching portion is in the first configuration then the resonating portion operates in odd mode and an electrical signal present at the set of output terminals will be in a first band, and (ii) when the band switching portion is in the second configuration then the resonating portion will operate in even mode and an electrical signal will present at the set of output terminals will be in a second band which is different from the first band;
wherein the resonating portion and the band switching portions are structured and/or connected so that substantially no current passes through any switch(es) of the set of switch(es) of the band switching portion when the resonating portion is operating: (i) in even mode, and (ii) in odd mode.

33. The method of claim 32 wherein:
the resonating portion comprises a first tank circuit including a first capacitor, a first inductor, a first terminal and a second terminal;
the resonating portion further comprises a second tank circuit including a first capacitor, a first inductor, a first terminal and a second terminal;
the first capacitor of the first tank circuit has at least substantially equal capacitance value to the first capacitor of the second tank circuit; and
the first inductor of the first tank circuit has at least substantially equal inductance value to the first inductor of the second tank circuit.

34. The method of claim 33 wherein:
when the oscillator operates in odd mode, the first and second tank circuits resonate at 180 degrees out of phase with each other; and
when the oscillator operates in even mode, the first and second tank circuits resonate in phase with each other.

35. The method of claim 33 wherein:
the oscillator circuit further comprises a first PFET pair and a second PFET pair;
the first PFET pair is structured and/or connected to provided electrical energy, as appropriate, to the first tank circuit; and
the second PFET pair is structured and/or connected to provided electrical energy, as appropriate, to the second tank circuit.

36. The method of claim 32 wherein:
when the band switching portion is in the first configuration so that the resonating portion is operating in odd mode, any closed switch(es) of the set of switches of the band switching portion will damp the even mode; and
when the band switching portion is in the second configuration so that the resonating portion is operating in even mode, any closed switch(es) of the set of switches of the band switching portion will damp the odd mode.

37. A wireless communication device comprising:
a first RF antenna;
a modulator/demodulator module;
a local oscillator;
an IF signal supply module; and
an IF signal receiving module;
wherein:
the local oscillator is structured and connected to selectively output a carrier signal to the modulator/demodulator module;
the IF signal supply module is structured and is connected to the modulator module to supply an outgoing IF signal at a predetermined intermediate frequency to the modulator module;
the modulator/demodulator module is structured and/or programmed to modulate the outgoing IF signal into an outgoing RF signal at a predetermined RF frequency based on the carrier signal from the local oscillator;
the first RF antenna is structured and/or connected to: (i) receive the outgoing RF signal from the modulator/demodulator module, and (ii) transmit the outgoing RF signal wirelessly;
the first RF antenna is further structured and/or programmed to receive an incoming RF signal wirelessly;
the modulator/demodulator module is structured and/or programmed to demodulate the incoming RF signal into an incoming IF signal at the predetermined IF frequency;
the IF signal receiving module is connected to the modulator/demodulator module to receive the incoming IF signal;
the local oscillator comprises a resonating portion, a band switching and a set of output terminals;
the band switching network, the resonator portion and the set of output terminals are operatively electrically coupled to each other;
the band switching portion comprising a set of switch(es);
the band switching portion is configurable between at least a first configuration and a second configuration;
the band switching potion is structured so that: (i) when the band switching portion is in the first configuration then the resonating portion operates in odd mode and an electrical signal present at the set of output terminals will be in a first band, and (ii) when the band switching portion is in the second configuration then the resonating portion will operate in even mode and an electrical signal will present at the set of output terminals will be in a second band which is different from the first band; and
the resonating portion and the band switching portions are structured and/or connected so that substantially no current passes through any switch(es) of the set of switch(es) of the band switching portion when the resonating portion is operating: (i) in odd mode, and (ii) in even mode.

38. The device of claim 37 wherein the outgoing IF signal, the outgoing RF signal, the incoming RF signal and the incoming IF signal all correspond to audio data.

39. The device of claim 37 further comprising a first chip wherein the local oscillator can produce carrier signals suitable for at least of the following communication schemes: GSM, Wi-Fi, WCDMA, CDMA, Blue Tooth and GPS.
